(19) United States
(12) Patent Application Publication
(10) Pub. No.: US 2025/0307835 A1
(43) Pub. Date: Oct. 2, 2025

(54) REMOTE CUSTOMER SERVICE SYSTEM, CONNECTION SERVER, AND METHOD USED IN REMOTE CUSTOMER SERVICE SYSTEM

(71) Applicant: GLORY LTD., Himeji-shi (JP)

(72) Inventors: Ryota NAKAMURA, Himeji-shi (JP); Hideo NOMOTO, Himeji-shi (JP); Risa MURAKOSHI, Himeji-shi (JP); Daisuke TERANISHI, Himeji-shi (JP)

(73) Assignee: GLORY LTD., Himeji-shi (JP)

(21) Appl. No.: 19/056,753

(22) Filed: Feb. 19, 2025

(30) Foreign Application Priority Data
Apr. 2, 2024 (JP) 2024-059484

(51) Int. Cl. G06Q 30/015; G06Q 30/0283; G06Q 30/04

(52) U.S. Cl. CPC G06Q 30/015; G06Q 30/0283; G06Q 30/04

(57) ABSTRACT

A remote customer service system configured to connect a client terminal in a customer booth, which is operated by a customer, and a target business operator which is one of a plurality of business operators providing services to realize remote conversation between the customer and a customer service staff who operates a customer service terminal of the target business operator. The remote customer service system includes a terminal obtainer configured to obtain desired service information indicative of one of the services desired by the customer, an information transmitter configured to transmit the desired service information obtained by the terminal obtainer, and a connection controller configured to connect the client terminal and the customer service terminal of the target business operator determined in accordance with the desired service information received from the information transmitter.

### CROSS-REFERENCE TO RELATED APPLICATION

The present application claims priority to Japanese Patent Application No. 2024-059484, filed on Apr. 2, 2024, the contents of which is hereby incorporated by reference in its entirety.

### BACKGROUND

### Field

The present disclosure relates to a remote customer service system, a connection server, and a method used in a remote customer service system.

### Description of the Related Art

For example, in an information processing device disclosed in JP 2022-61842A, a client terminal installed in each store and a customer service terminal operated by a customer service staff (referred to as a “staff” in the document) are connected via a network. A conventional remote customer service system like that disclosed in JP 2022-61842A aims chiefly at remote conversation between a customer and a customer service staff. There is a limit to services that can be provided to customers merely through remote conversation. Therefore, there is demand for a remote customer service system that can provide various services as desired by customers. An object of the present disclosure is to provide a remote customer service system and the like that can provide various services to customers.

### SUMMARY

As a means for solving the above issue, a remote customer service system according to a first aspect of the present disclosure is configured to connect a client terminal in a customer booth, which is operated by a customer, and a target business operator which is one of a plurality of business operators providing services to realize remote conversation between the customer and a customer service staff who operates a customer service terminal of the target business operator, the remote customer service system including:
a terminal obtainer included in the client terminal and configured to obtain desired service information indicative of one of the services desired by the customer;
an information transmitter included in the client terminal and configured to transmit the desired service information obtained by the terminal obtainer; and
a connection controller configured to connect the client terminal and the customer service terminal of the target business operator determined in accordance with the desired service information received from the information transmitter.

In one preferred embodiment of the present disclosure, the remote customer service system further includes:
a determiner configured to automatically determine the target business operator from the plurality of business operators in accordance with the received desired service information,
wherein the connection controller is configured to connect the client terminal and the customer service terminal of the target business operator determined by the determiner.

In one preferred embodiment of the present disclosure, the remote customer service system further includes:
an intermediary terminal configured to be operated by an operator,
the intermediary terminal including:
   a notification device configured to notify the operator of the desired service information received from the information transmitter; and
   an input interface configured to receive, from the operator, input of the target business operator determined by the operator, and
wherein the connection controller is configured to connect the client terminal and the customer service terminal of the target business operator received by the input interface.

In one preferred embodiment of the present disclosure,
a plurality of categories into which the services are sorted according to types of businesses are set, and
the remote customer service system further includes:
   a storage storing information of different fees corresponding to the plurality of categories; and
   a connection permission controller configured to read information of a fee corresponding to one of the categories from the storage based on the desired service information, to permit connection between the customer service terminal of the target business operator and the client terminal in response to the customer paying the fee in a case of the fee being charged, and to permit connection between the customer service terminal of the target business operator and the client terminal in a case of the fee being free.

In one preferred embodiment of the present disclosure,
a plurality of sub categories that belong to the categories and into which the services are sorted according to service contents are set,
the storage stores information of different fees corresponding to the plurality of sub-categories, and
the connection permission controller is configured to read information of a fee corresponding to one of the sub-categories from the storage based on the desired service information, to permit connection between the customer service terminal of the target business operator and the client terminal in response to the customer paying the fee in a case of the fee being charged, and to permit connection between the customer service terminal of the target business operator and the client terminal in a case of the fee being free.

In one preferred embodiment of the present disclosure,
the client terminal is installed in each of a plurality of stores, and
the remote customer service system further includes:
   a storage storing information of different fees corresponding to the plurality of stores; and
   a connection permission controller configured to read, from the storage, information of a fee corresponding to a store in which the customer uses the client terminal among the plurality of stores, to permit connection between the customer service terminal of the target business operator and the client terminal in the store in response to the customer paying the fee in a case of the fee being charged, and to permit connection between the customer service terminal of the target business operator and the client terminal in the store in a case of the fee being free.

In one preferred embodiment of the present disclosure,
the terminal obtainer is configured to obtain the desired service information by reading information from a medium held by the customer.

In one preferred embodiment of the present disclosure, the remote customer service system further includes:
a medium issuer configured to issue the medium in a store including the customer booth.

In one preferred embodiment of the present disclosure, the remote customer service system further includes:
a billing information generator configured to generate billing information for the business operator based on a state of connection to the business operator.

In one preferred embodiment of the present disclosure,
the billing information generator is configured to generate the billing information based on a connection count of connection to the business operator.

In one preferred embodiment of the present disclosure,
the billing information generator is configured to generate the billing information based on a connection time of connection to the business operator.

In one preferred embodiment of the present disclosure, the remote customer service system further includes:
an upper limit time setting unit configured to set an upper limit time for a continuous connection time for which the client terminal and the business operator are connected,
wherein the upper limit time setting unit is configured to automatically cut off connection between the client terminal and the business operator in response to the continuous connection time reaching the upper limit time.

In one preferred embodiment of the present disclosure,
the upper limit time setting unit is configured to maintain the connection between the client terminal and the business operator beyond the original upper limit time in response to an operation made by the customer service staff.

In one preferred embodiment of the present disclosure, the remote customer service system further includes:
a necessary document determiner configured to determine a necessary document for the service desired by the customer based on the desired service information; and
a notification controller configured to control a notification device of the client terminal to notify the customer of the determined necessary document.

In one preferred embodiment of the present disclosure,
the notification controller controls the notification device of the client terminal to give a notification prompting the customer to obtain the necessary document at a store in which the client terminal is installed.

In one preferred embodiment of the present disclosure, the remote customer service system further includes:
a coupon issuer configured to issue, in response to the connection controller connecting the customer service terminal of the target business operator and the client terminal, a coupon usable at a store in which the client terminal is installed or a nearby store.

As a means for solving the above issue, a connection server according to a second aspect of the present disclosure is configured to connect a client terminal in a customer booth, which is operated by a customer, and a target business operator which is one of a plurality of business operators providing services to realize remote conversation between the customer and a customer service staff who operates a customer service terminal of the target business operator, the connection server including:
an information receiver configured to receive desired service information indicative of one of the services desired by the customer from the client terminal; and
a connection controller configured to connect the client terminal and the customer service terminal of the target business operator determined in accordance with the received desired service information.

As a means for solving the above issue, a method according to a third aspect of the present disclosure is a method performed in a remote customer service system configured to connect a client terminal in a customer booth, which is operated by a customer, and a target business operator which is one of a plurality of business operators providing services to realize remote conversation between the customer and a customer service staff who operates a customer service terminal of the target business operator, the method including:
an obtaining step of obtaining desired service information indicative of one of the services desired by the customer with use of the client terminal;
a transmitting step of transmitting the desired service information obtained in the obtaining step from the client terminal; and
a connecting step of connecting the client terminal and the customer service terminal of the target business operator determined in accordance with the desired service information transmitted from the client terminal.

According to the present disclosure, a remote customer service system that can provide various services to customers is realized.

The following detailed description of embodiments referring to the drawings will further clarify the above embodiments and other embodiments, procedures, features, and effects of the present disclosure.

### BRIEF DESCRIPTION OF THE DRAWINGS

FIG. 1 is a block diagram showing an example of a remote customer service system.

FIG. 2 is a diagram showing an example of a relationship between fees and a plurality of categories and sub-categories into which services are sorted according to types of businesses.

FIG. 3 is a diagram showing a flow of actions taken by a customer who uses the remote customer service system and a customer service staff and automatic processing.

FIG. 4 is a flowchart showing a flow of connecting a target business operator and a client terminal based on desired service information.

FIG. 5 is a flowchart showing a flow after the target business operator and the client terminal are connected.

FIG. 6 is a diagram showing devices that are activated according to types of services.

### DETAILED DESCRIPTION OF THE PREFERRED EMBODIMENTS

### [Basic Configuration of Remote Customer Service System]

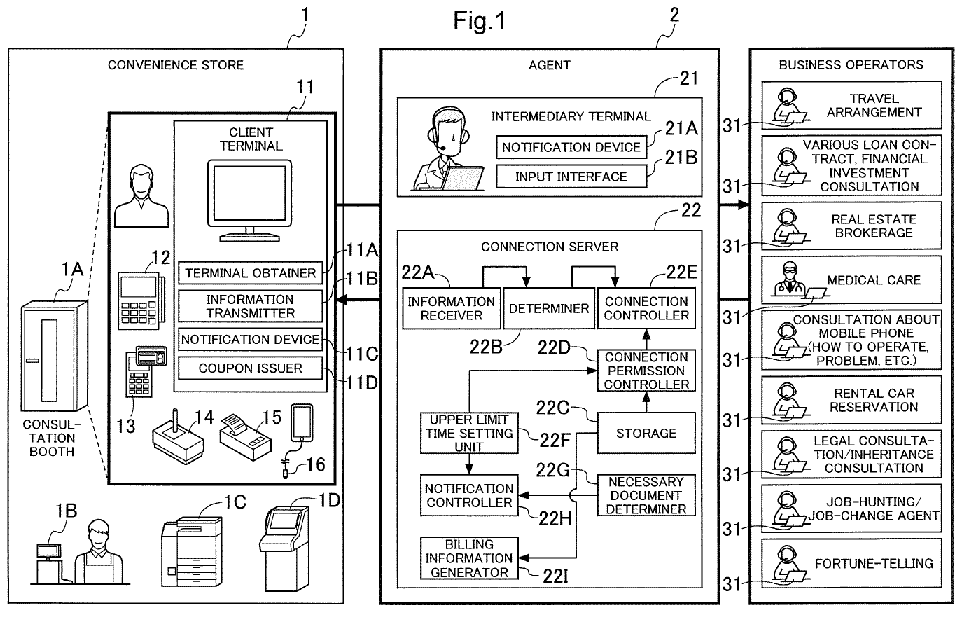

As shown in FIG. 1, a remote customer service system according to the present disclosure includes a client terminal 11 installed in a convenience store 1, an intermediary terminal 21 that is used by an agent 2, a connection server 22 that is used by the agent 2, and customer service terminals 31 that are used by business operators providing services. The client terminal 11, the intermediary terminal 21, and the customer service terminals 31 are each connectable to the connection server 22. The client terminal 11, the intermediary terminal 21, the connection server 22, and the customer service terminals 31 each include a data communication module and are capable of communicating with each other (capable of transmitting and receiving video, audio, and other data) by being connected via LANs in respective facilities and a wide area network. The LAN in each facility may include wired communication in accordance with communication standards such as IEEE1394 or Ethernet, for example. Also, the LAN in each facility may include wireless communication (Bluetooth, Wi-Fi, etc.) in accordance with communication standards such as IEEE802, for example. The wide area network may include a broadband Internet communication network using optical fiber cables and a mobile communication system of 4G or 5G, for example.

In the present embodiment, the convenience store 1 includes a consultation booth 1A (customer booth), a cash register 1B of a POS (Point Of Sale) system, a multifunctional copy machine 1C, and a multifunctional information communication terminal 1D. The cash register 1B, the multifunctional copy machine 1C, and the multifunctional information communication terminal 1D each include a data communication module and a controller including a processor and are capable of communicating data via the LAN in the convenience store 1 and the wide area network. Note that the multifunctional copy machine 1C and the multifunctional information communication terminal 1D may also be integrated. Also, the multifunctional information communication terminal 1D and an automatic teller machine (not shown) may also be integrated.

Although FIG. 1 shows only one convenience store 1, the consultation booth 1A and the client terminal 11 are installed in a plurality of stores, and the connection server 22 is connectable to each of the plurality of client terminals 11.

The consultation booth 1A has an area of 1 to 2 square meters. The consultation booth 1A is a private room surrounded by walls (including soundproof walls) and a door (including a soundproof door) on the left and right sides and the front and rear sides and at its top like a telephone booth to secure privacy. The client terminal 11, a card reader 12, a scanner 13, a seal scanner 14, a small printer 15, and a connection device 16 connectable to a smartphone or the like are installed in the consultation booth 1A. The card reader 12, the scanner 13, the seal scanner 14, the small printer 15, and the connection device 16 each include a data communication module and a controller including a processor and may be connected to the client terminal 11 or the LAN in the convenience store 1 by a serial communication cable. The scanner 13 may be either a contact scanner or a contactless scanner, or may have both a contact scanner function and a contactless scanner function.

As shown in FIG. 1, business operators respectively provide different services such as travel arrangement, contract of various loans, contract of real estates, medical care, consultation about mobile phones, reservation of rental cars, legal consultation, inheritance consultation, job-hunting/job-change agent, fortune-telling, etc. The customer service terminal 31 is provided in each business operator. The customer service terminal 31 includes a non-volatile memory (not shown) storing a program therein and a processor (not shown) that executes the program, and is capable of executing various types of control in accordance with the program. The processor can be realized by an FPGA (Field Programmable Gate Array), a GPU (Graphics Processing Unit), an ASIC (Application Specific Integrated Circuit), an ASSP (Application Specific Standard Product), or a combination of two or more circuits selected from these circuits, in addition to a CPU (Central Processing Unit). When the program is executed by the processor, various functions of the customer service terminal 31 are realized. The program may be constituted by an execution program generated by a compiler and a linker or codes sequentially executed by an interpreter, for example. Note that a plurality of customer service terminals 31 may also be provided in a business operator. A customer service staff of each business operator remotely provides, with use of the customer service terminal 31, a service to a customer who uses the client terminal 11. Note that the customer service staff may also be the owner or manager of the business operator.

The remote customer service system according to the present disclosure connects the client terminal 11 installed in the customer booth (consultation booth 1A) and operated by a customer and one of the plurality of business operators providing services to realize remote conversation between the customer and a customer service staff who operates the customer service terminal 31 of a target business operator.

The client terminal 11 includes a terminal obtainer 11A, an information transmitter 11B, a notification device 11C, and a coupon issuer 11D. The client terminal 11 also includes a controller (not shown) that controls each constituent element of the client terminal 11. The controller includes a non-volatile memory (not shown) storing a program therein and a processor (not shown) that executes the program, and is capable of executing various types of control in accordance with the program. The processor can be realized by an FPGA (Field Programmable Gate Array), a GPU (Graphics Processing Unit), an ASIC (Application Specific Integrated Circuit), an ASSP (Application Specific Standard Product), or a combination of two or more circuits selected from these circuits, in addition to a CPU (Central Processing Unit). When the program is executed by the processor, various functions of the client terminal 11 are realized. The program may be constituted by an execution program generated by a compiler and a linker or codes sequentially executed by an interpreter, for example. The terminal obtainer 11A obtains desired service information indicative of a service desired by the customer. The desired service information is, for example, an operation made by the customer to select a service, input of information (e.g., reading of a two-dimensional code) identifying a service, or the voice of the customer saying the desired service. The information transmitter 11B transmits the desired service information obtained by the terminal obtainer 11A to the outside. The notification device 11C is constituted by, for example, a display or a speaker configured to give audio guidance, and notifies the customer of various types of information. The coupon issuer 11D is configured to issue a discount coupon or the like that can be used at the store where the client terminal 11 is installed or a nearby store.

In the present embodiment, the intermediary terminal 21 is installed in a call center of the agent 2. An operator or the like in the call center first confirms the service that the customer using the client terminal 11 wants to use, for example, and then asks the business operator providing the service whether or not a customer service staff in the business operator can attend to the customer. If a customer service staff in the business operator providing the service can attend to the customer, the operator or the like in the call center connects the client terminal 11 and the customer service terminal 31.

The intermediary terminal 21 includes a notification device 21A and an input interface 21B. The intermediary terminal 21 also includes a controller (not shown) that controls each constituent element of the intermediary terminal 21. The controller includes a non-volatile memory (not shown) storing a program therein and a processor (not shown) that executes the program, and is capable of executing various types of control in accordance with the program. The processor can be realized by an FPGA (Field Programmable Gate Array), a GPU (Graphics Processing Unit), an ASIC (Application Specific Integrated Circuit), an ASSP (Application Specific Standard Product), or a combination of two or more circuits selected from these circuits, in addition to a CPU (Central Processing Unit). When the program is executed by the processor, various functions of the intermediary terminal 21 are realized. The program may be constituted by an execution program generated by a compiler and a linker or codes sequentially executed by an interpreter, for example. The notification device 21A notifies the operator of the desired service information received from the information transmitter 11B. The operator of the intermediary terminal 21 determines a target business operator to which the client terminal 11 is to be connected from a plurality of business operators providing services, based on the desired service information by making confirmation to the customer. Then, the operator confirms whether or not the determined target business operator can provide the service and connects the client terminal 11 and the customer service terminal 31 of the target business operator by operating the input interface 21B. Accordingly, the input interface 21B receives, from the operator, input of the target business operator determined by the operator.

The connection server 22 is installed in a data center of the agent 2, for example. The connection server 22 connects the client terminal 11 and one (the target business operator) of the plurality of business operators providing services to realize remote conversation between the customer and a customer service staff operating the customer service terminal 31. The connection server 22 includes an information receiver 22A, a determiner 22B, a storage 22C, a connection permission controller 22D, a connection controller 22E, an upper limit time setting unit 22F, a necessary document determiner 22G, a notification controller 22H, and a billing information generator 22I. The connection server 22 also includes a controller (not shown) that controls each constituent element of the connection server 22. The controller includes a non-volatile memory (not shown) storing a program therein and a processor (not shown) that executes the program, and is capable of executing various types of control in accordance with the program. The processor can be realized by an FPGA (Field Programmable Gate Array), a GPU (Graphics Processing Unit), an ASIC (Application Specific Integrated Circuit), an ASSP (Application Specific Standard Product), or a combination of two or more circuits selected from these circuits, in addition to a CPU (Central Processing Unit). When the program is executed by the processor, various functions of the connection server 22 are realized. The program may be constituted by an execution program generated by a compiler and a linker or codes sequentially executed by an interpreter, for example.

The information receiver 22A receives the desired service information transmitted from the information transmitter 11B of the client terminal 11. The information receiver 22A transmits the desired service information transmitted from the information transmitter 11B to the notification device 21A of the intermediary terminal and the determiner 22B.

The determiner 22B determines a target business operator to which the client terminal is to be connected, from the plurality of business operators based on a signal from the intermediary terminal 21. In the present embodiment, the target business operator is determined by the operator of the intermediary terminal 21. Accordingly, when the operator who has determined the target business operator operates the input interface 21B, the determiner 22B receives a signal that is output in response to the input interface 21B receiving input by the operator.

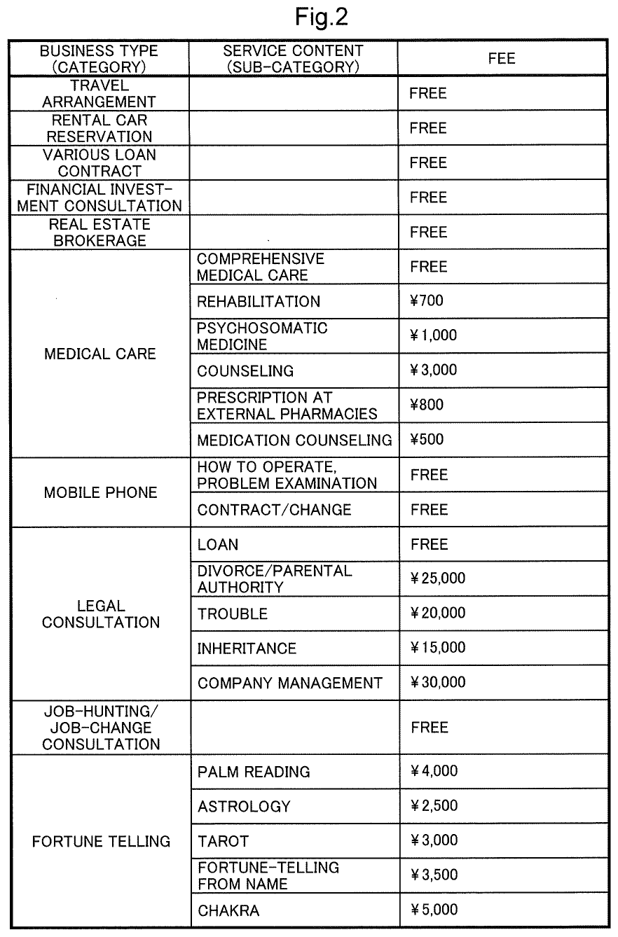

The storage 22C includes a storage medium (e.g., a hard disk or a flash memory). For example, a fee for connection between the client terminal 11 and the customer service terminal 31 of the target business operator is stored in the storage 22C. In many cases, different fees are charged according to the type or content of service. Accordingly, in the present embodiment, a plurality of categories into which services are sorted according to the types of businesses are set as shown in FIG. 2. In addition, a plurality of sub-categories into which services are sorted according to service contents are set in the categories. The storage 22C stores information of different fees corresponding to the plurality of categories and sub-categories belonging to the categories. The storage 22C also stores a connection count and a total connection time of connection between the client terminal 11 and the customer service terminal 31 of each business operator. Note that the fee information also includes information indicating that the fee is free.

The connection permission controller 22D determines whether or not conditions for the connection between the client terminal 11 and the customer service terminal 31 of the target business operator are satisfied, and if the conditions are satisfied, permits the connection between the client terminal 11 and the customer service terminal 31 of the target business operator.

In response to the connection permission controller 22D permitting the connection, the connection controller 22E connects the client terminal 11 and the customer service terminal 31 of the target business operator determined by the determiner 22B. In other words, the connection controller 22E connects the client terminal 11 and the customer service terminal 31 of the target business operator determined in accordance with the desired service information received from the information transmitter 11B via the information receiver 22A. Specifically, the connection controller 22E receives the voice and image of the customer (or the voice and image of the customer service staff) from the client terminal 11 (or the customer service terminal 31) and transmits the voice and image to the customer service terminal 31 (or the client terminal 11). This realizes remote conversation between the customer service staff operating the customer service terminal 31 and the customer operating the client terminal 11.

The upper limit time setting unit 22F sets an upper limit time for a continuous connection time for which the customer service terminal 31 and the client terminal 11 are connected. The upper limit time setting unit 22F is configured to automatically cut off the connection between the client terminal 11 and the customer service terminal 31 of the target business operator in response to the continuous connection time reaching the upper limit time. Note that the upper limit time setting unit 22F is capable of changing the setting to maintain the connection between the client terminal 11 and the customer service terminal 31 of the target business operator beyond the original upper limit time.

The necessary document determiner 22G determines a necessary document for the service desired by the customer based on the desired service information indicative of the service desired by the customer. The necessary document is a document necessary for the customer to use the service, such as a certificate of residence, a certificate of seal registration, a certificate of tax payment, etc.

The notification controller 22H controls the notification device 11C of the client terminal 11. The notification controller 22H is configured to notify the customer of the necessary document determined by the necessary document determiner 22G via the notification device 11C. In addition, the notification controller 22H is configured to notify the customer of the upper limit time set by the upper limit time setting unit 22F and a remaining time to the upper limit time, etc., with controlling the notification device 11C.

The billing information generator 22I generates billing information for each business operator based on the status of connection to the business operator. The status of connection to the business operator includes a connection count and a connection time of the connection to the business operator. Based on the billing information generated by the billing information generator 22I, the agent 2 charges each business operator a usage fee of the remote customer service system. In addition, the agent 2 pays a part of the usage fee received from each business operator to the convenience store 1 where the customer used the consultation booth 1A.

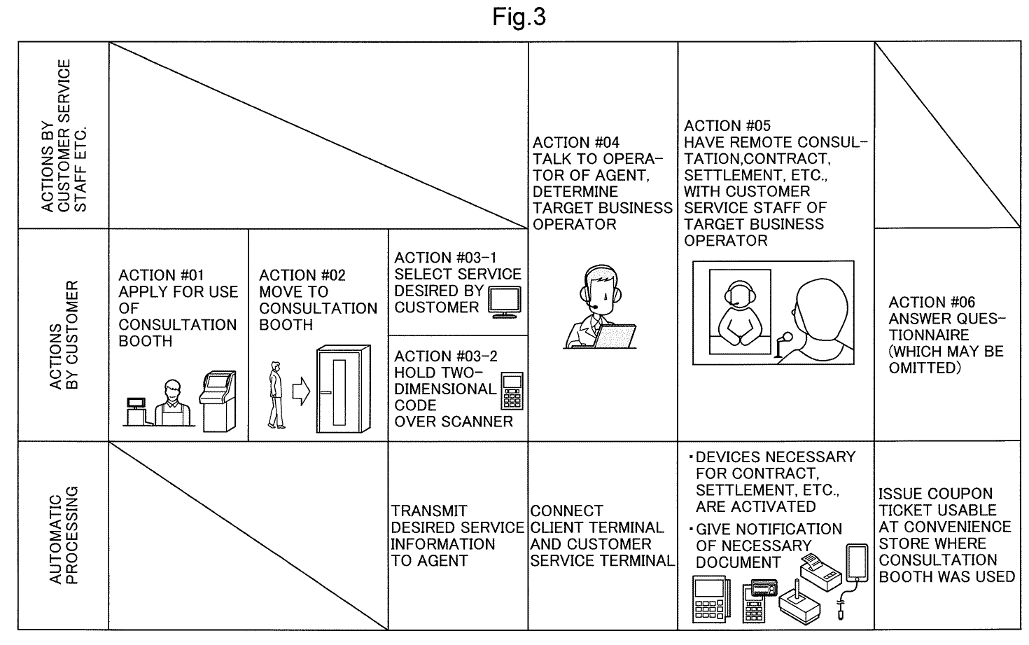

FIG. 3 shows actions taken by a customer and a customer service staff and automatic processing performed by the remote customer service system in chronological order. First, the customer applies for use of the consultation booth 1A (action #01). A staff may operate the cash register 1B in response to a request from the customer to make the application for use, or the customer may operate the multifunctional information communication terminal 1D to make the application for use. If the customer uses a charged service, the customer may pay the fee at a counter.

When the application for use is complete, a medium such as a receipt is printed out from the cash register 1B or the multifunctional information communication terminal 1D. The cash register 1B and the multifunctional information communication terminal 1D correspond to a “medium issuer” that is installed in the store (the convenience store 1) including the consultation booth 1A and issues a medium.

The customer receives the medium such as a receipt and takes the medium to the consultation booth 1A (action #02). Then, the customer selects a desired service by operating a touch panel screen or the like included in the client terminal 11 (action #3-1). At this time, the terminal obtainer 11A of the client terminal 11 obtains desired service information based on the operation made by the customer.

Alternatively, if a two-dimensional code indicative of information about the desired service is given in advance on the medium such as a receipt, the customer may hold the two-dimensional code over the scanner 13 (action #3-2). In this case, the terminal obtainer 11A of the client terminal 11 obtains the desired service information from the two-dimensional code read by the scanner 13. The terminal obtainer 11A obtains the desired service information based on the operation made by the customer. That is to say, the terminal obtainer 11A is configured to obtain the desired service information by reading the information from the medium held by the customer.

In both the above actions #3-1 and #3-2, the terminal obtainer 11A obtains the desired service information. The information transmitter 11B transmits the desired service information to the agent 2. The customer then talks to an operator of the agent 2, and the operator asks any questions to the customer about the desired service (action #04). Voice data of the customer taken at this time indicates the service desired by the customer, and accordingly, is an example of the desired service information. The operator of the agent 2 then determines a business operator that is the closest to the customer's desire from the plurality of business operators providing services as the target business operator to which the client terminal 11 is to be connected, based on the desired service information and matter obtained by directly asking the customer.

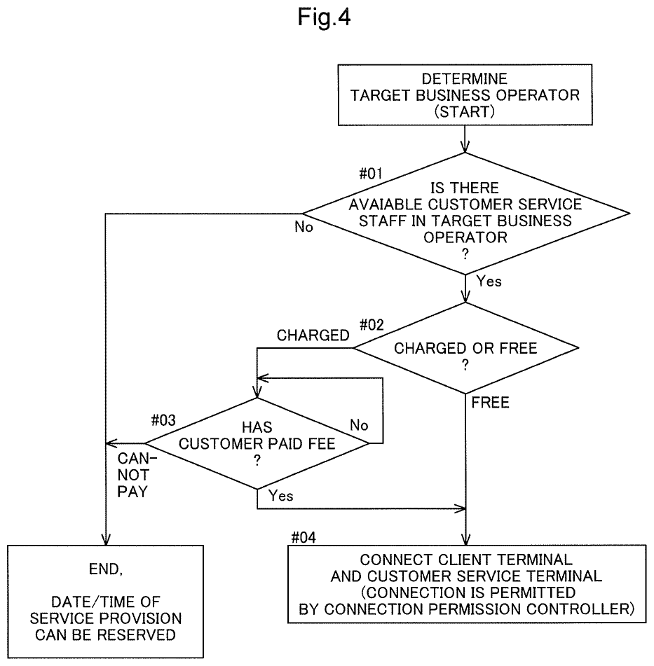

The following describes a flow from the determination of the target business operator to the connection between the client terminal 11 and the customer service terminal 31 of the target business operator based on FIG. 4. For example, the determiner 22B confirms whether or not there is an available customer service staff in the target business operator (step #01 in FIG. 4). If there is no available customer service staff in the target business operator (step #01: No), the client terminal 11 and the customer service terminal 31 of the target business operator are not connected and the flow ends. At this time, the operator of the agent 2 can also make a reservation for the date and time of service provision by asking the customer about the availability of the date and time. The connection server 22 may also be configured to automatically perform processing (presenting the date and time of service provision, accepting a reservation from the customer, notifying the target business operator, etc.) for the next reservation.

If there is an available customer service staff in the target business operator (step #01: Yes), the connection permission controller 22D determines whether or not the service is charged (step #02 in FIG. 4). At this time, the connection permission controller 22D reads information of the fee corresponding to one of the plurality of categories and sub-categories belonging to the categories from the storage 22C based on the desired service information.

A charged service is a service for which consultation itself is charged. As shown in FIG. 2, examples of charged services include legal consultation, inheritance consultation, fortune-telling, and medical care. A free service is a service for which consultation itself is free. As shown in FIG. 2, examples of free services include consultation on rental car reservations, consultation on how to operate mobile phones, real estate brokerage, consultation on financial investment products, consultation on various loans, and consultation on job hunting and job change.

If the service is free (step #02: Free), the connection permission controller 22D permits the connection between the customer service terminal 31 of the target business operator and the client terminal 11. Then, the connection controller 22E connects the client terminal 11 and the customer service terminal 31 of the target business operator received by the input interface 21B (step #04 in FIG. 4).

If the service is charged (step #02: Charged), the connection permission controller 22D confirms whether or not the fee has already been paid (step #03 in FIG. 4). If the customer has paid the fee (step #03: Yes), the connection permission controller 22D permits the connection between the customer service terminal 31 of the target business operator and the client terminal 11. Then, the connection controller 22E connects the client terminal 11 and the customer service terminal 31 of the target business operator received by the input interface 21B (step #04 in FIG. 4).

If the customer has not paid the fee (step #03: No), the notification controller 22H controls the notification device 11C to prompt the customer to pay the fee, for example. At this time, the operator of the agent 2 may also prompt the customer to pay the fee. At this time, the customer pays the fee by having their credit card, prepaid card, etc., read by the card reader 12, holding an IC chip payment card or smartphone over the scanner 13, or making the payment at the counter in the convenience store 1. When the payment of the fee is complete (step #03: Yes), the connection permission controller 22D permits the connection between the customer service terminal 31 of the target business operator and the client terminal 11. Then, the connection controller 22E connects the client terminal 11 and the customer service terminal 31 of the target business operator received by the input interface 21B (step #04 in FIG. 4).

If the customer cannot pay the fee immediately (step #03: Cannot pay), the client terminal 11 and the customer service terminal 31 of the target business operator are not connected and the flow ends. At this time, the operator of the agent 2 can also make a reservation for the date and time of service provision by asking the customer about the availability of the date and time. The connection server 22 may automatically perform processing (presenting the date and time of service provision, accepting a reservation, notifying the target business operator, etc.) for the next reservation.

As described above, in a case of the fee being charged, the connection permission controller 22D permits the connection between the customer service terminal 31 of the target business operator and the client terminal 11 in response to the customer paying the fee, and in a case of the fee being free, the connection permission controller 22D permits the connection between the customer service terminal 31 of the target business operator and the client terminal 11.

When the client terminal 11 and the customer service terminal 31 of the target business operator are connected, the customer remotely consults the customer service staff of the target business operator and makes a contract, settlement, or the like as necessary as shown in action #05 in FIG. 3. At this time, the customer is notified of a necessary document by the notification device 11C. In addition, devices necessary for the contract or settlement (the card reader 12, the scanner 13, the seal scanner 14, the small printer 15, the connection device 16, etc.,) are activated.

After the remote consultation between the customer and the customer service staff ends, the customer answers a questionnaire as shown in action #06 in FIG. 3. The questionnaire may be omitted. Then, a coupon ticket that can be used at the convenience store 1 where the consultation booth 1A was used is issued. This stimulates the customer's willingness to buy, making it easier for the customer to buy products at the convenience store 1 that they would not have originally planned to buy. This benefits both the convenience store 1 and the customer. Therefore, this facilitates installation of the consultation booth 1A and the client terminal 11 in the convenience store 1 by the owner or the like of the convenience store 1.

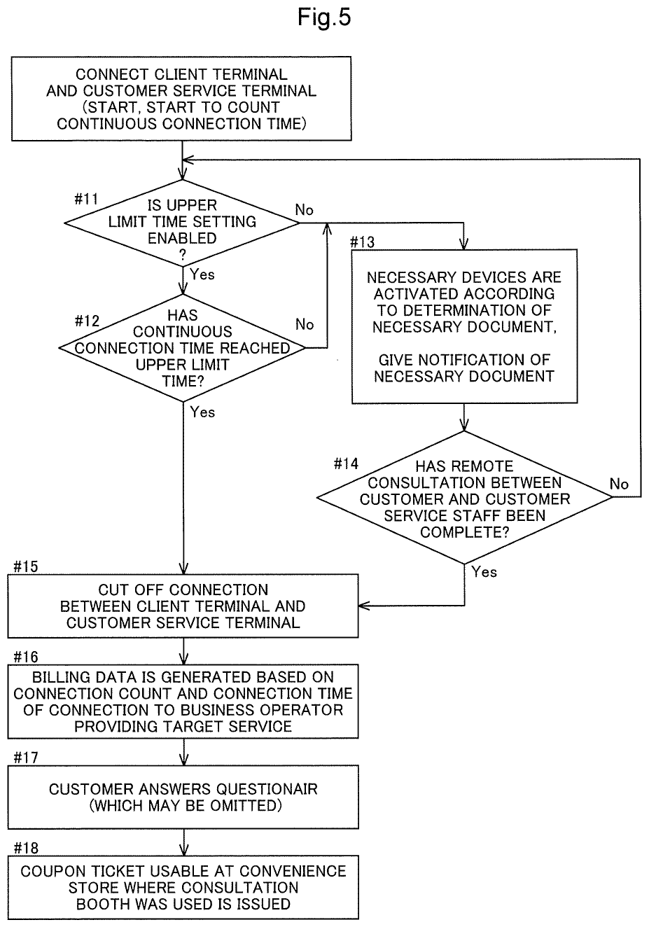

The following describes the flow from action #05 to action #06 shown in FIG. 3 based on the flowchart shown in FIG. 5. First, when the client terminal 11 and the customer service terminal 31 of the target business operator are connected, the continuous connection time of the connection between the client terminal 11 and the customer service terminal 31 is started to be counted. Then, whether or not the setting of the upper limit time set by the upper limit time setting unit 22F is enabled is determined (step #11 in FIG. 5).

If the setting of the upper limit time set by the upper limit time setting unit 22F is enabled (step #11: Yes), the upper limit time setting unit 22F determines whether or not the continuous connection time has reached the upper limit time (step #12 in FIG. 5). Note that the customer service staff can extend the upper limit time or disable the setting of the upper limit time by operating the customer service terminal 31. That is to say, the upper limit time setting unit 22F is configured to maintain the connection between the client terminal 11 and the business operator beyond the original upper limit time in response to an operation made by the customer service staff.

When the continuous connection time has reached the upper limit time (step #12: Yes), a disconnection command signal is output from the connection permission controller 22D to the connection controller 22E, and the connection controller 22E cuts off the connection between the client terminal 11 and the customer service terminal 31 of the target business operator (step #15 in FIG. 5).

If the setting of the upper limit time set by the upper limit time setting unit 22F is disabled (step #11: No) or the continuous connection time has not reached the upper limit time (step #12: No), the remote consultation between the customer and the customer service staff is continued. At this time, the necessary document determiner 22G determines a necessary document for the service desired by the customer based on the desired service information. Then, the notification controller 22H notifies the customer of the necessary document as necessary by controlling the notification device 11C of the client terminal 11 (step #13 in FIG. 5). In addition, necessary devices (the card reader 12, the scanner 13, the seal scanner 14, the small printer 15, the connection device 16, etc.,) are activated in step #13 in accordance with the determination made by the necessary document determiner 22G.

Even if the customer does not have the necessary document, it is often possible to print the document with the multifunctional copy machine 1C. Therefore, in step #13, the notification controller 22H controls the notification device 11C to give a notification prompting the customer to obtain the necessary document with use of the multifunctional copy machine 1C at the convenience store 1 where the client terminal 11 is installed. Examples of documents that can be printed with use of the multifunctional copy machine 1C include a certificate of residence, a certificate of seal registration, and a certificate of tax payment. This allows the customer to quickly get the necessary document.

If the remote consultation between the customer and the customer service staff has not been complete (step #14: No), the process will be repeated from step #11. When the remote consultation between the customer and the customer service staff is complete (step #14: Yes), an end signal is transmitted from the customer service terminal 31 to the connection server 22, and the connection controller 22E cuts off the connection between the client terminal 11 and the customer service terminal 31 of the target business operator (step #15 in FIG. 5).

When the connection between the client terminal 11 and the customer service terminal 31 is cut off, the billing information generator 22I generates billing information for the business operator that has provided the target service based on the status of connection to the business operator (step #16 in FIG. 5). The billing information generator 22I counts the number of times of connection between the client terminal 11 and the customer service terminal 31 for each business operator. Accordingly, the billing information generator 22I is configured to generate billing information based on a connection count and a connection time of connection to the business operator. If a billing information file has already been generated, the billing information generator 22I overwrites the billing information file with an updated connection count and an updated total connection time and saves the updated billing information file in step #16.

The customer answers a questionnaire as shown in action #06 in FIG. 3 (step #17 in FIG. 5). The questionnaire may be omitted. Then, in response to the connection controller 22E connecting the customer service terminal 31 of the target business operator and the client terminal 11, the coupon issuer 11D of the client terminal 11 issues a coupon that can be used at the convenience store 1 where the client terminal 11 is installed or a nearby store (step #18 in FIG. 5).

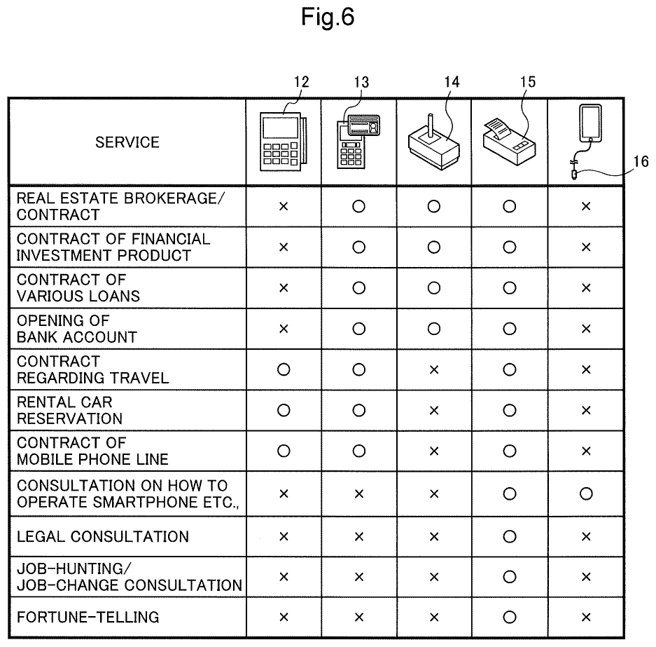

The following describes activation of necessary devices in step #13 with reference to FIG. 6. In FIG. 6, devices to be activated are indicated by circles, and devices not to be activated are indicated by crosses.

An ID card and a seal are necessary to make a contract of a real estate, a contract of a financial investment product, a contract of various loans, or open a bank account, for example. Therefore, the necessary document determiner 22G activates the scanner 13 to read an ID card and activate the seal scanner 14 to read a seal.

Cashless payment or the like using a credit card, a smartphone, or a contactless IC card is necessary to make a contract regarding travel, for example. Therefore, the necessary document determiner 22G activates the card reader 12 to enable payment using a credit card, or activates the scanner 13 to enable cashless payment.

In the case of rental car reservation, a driver's license needs to be checked. Also, a credit card, cashless payment, or the like is necessary. Therefore, the necessary document determiner 22G activates at least one of the card reader 12 and the scanner 13 to check the driver's license and enable payment.

In order to make a new contract of a mobile phone line, an ID card is necessary, and a credit card, a bank account information, or the like for monthly withdrawal is necessary. Therefore, the necessary document determiner 22G activates the scanner 13 to read an ID card. If the customer wants to use a credit card for monthly withdrawal, the necessary document determiner 22G activates the card reader 12 to read the credit card. If the customer wants to use account transfer for monthly withdrawal, the necessary document determiner 22G activates the scanner 13 to read a deposit passbook. Alternatively, the necessary document determiner 22G activates the card reader 12 to read the bank's cash card.

When the customer consults about how to use a smartphone or problems about the smartphone, it is necessary to connect a cable of the connection device 16 to a terminal of the smartphone in order to check settings of the smartphone, version information of the operating system (OS), etc. In this case, the necessary document determiner 22G activates the connection device 16.

In any of the above cases described with reference to FIG. 6, a description of important matter or the like may be displayed on the display of the client terminal 11, and the customer service staff may give an explanation about the description of important matter or the like to the customer. Note that the touch panel display of the client terminal 11 may display an electronic signature field for the customer to sign. In addition, a contract document may be printed by the small printer 15 and the customer may receive the contract document from the small printer 15.

In the case of legal consultation, inheritance consultation, job-hunting/job-change consultation, fortune-telling, etc., the necessary document determiner 22G activates none of the card reader 12, the scanner 13, and the seal scanner 14. At this time, the customer service staff gives various explanations while displaying materials on the display of the client terminal 11. In addition, a consultation report, a fortune-telling result, or the like may be printed by the small printer 15 and the customer may receive the report or result from the small printer 15.

### Effects of Embodiment

The present disclosure relates to a remote customer service system configured to connect a client terminal 11 in a customer booth (consultation booth 1A), which is operated by a customer, and a target business operator which is one of a plurality of business operators providing services to realize remote conversation between the customer and a customer service staff who operates a customer service terminal 31 of the target business operator, the remote customer service system including: a terminal obtainer 11A included in the client terminal 11 and configured to obtain desired service information indicative of a service desired by the customer; an information transmitter 11B included in the client terminal 11 and configured to transmit the desired service information obtained by the terminal obtainer 11A; and a connection controller 22E configured to connect the client terminal 11 and the customer service terminal 31 of the target business operator determined in accordance with the desired service information received from the information transmitter 11B.

According to this configuration, the terminal obtainer 11A of the client terminal 11 obtains information about the service desired by the customer, and the connection controller 22E connects the customer service terminal 31 and the client terminal 11, whereby conversation between the customer and the customer service staff is realized. Accordingly, one business operator is selected from the plurality of business operators providing services according to the service desired by the customer, and it becomes easier for the selected business operator to provide an appropriate service to the customer. Therefore, a remote customer service system that can provide various services to customers is realized.

The remote customer service system according to the present disclosure includes an intermediary terminal 21 that is operated by an operator, wherein the intermediary terminal 21 includes: a notification device 21A configured to notify the operator of the desired service information received from the information transmitter 11B; and an input interface 21B configured to receive, from the operator, input of the target business operator determined by the operator, and the connection controller 22E is configured to connect the client terminal 11 and the customer service terminal 31 of the target business operator received by the input interface 21B.

With this configuration, the operator of the intermediary terminal 21 can accurately ascertain the customer's desire by asking the customer and select the target business operator providing a service that is the closest to the customer's desire.

In the remote customer service system according to the present disclosure, a plurality of categories into which the services are sorted according to types of businesses are set, and the remote customer service system includes: a storage 22C storing information of different fees corresponding to the plurality of categories; and a connection permission controller 22D configured to read information of a fee corresponding to one of the categories from the storage 22C based on the desired service information, to permit connection between the customer service terminal 31 of the target business operator and the client terminal 11 in response to the customer paying the fee in a case of the fee being charged, and to permit connection between the customer service terminal 31 of the target business operator and the client terminal 11 in a case of the fee being free.

In this configuration, even if different fees are set for the respective services according to the types of businesses, the fees are stored in the storage 22C. Therefore, a configuration is realized in which a service is provided to the customer after the fee is collected from the customer.

In the remote customer service system according to the present disclosure, a plurality of sub-categories that belong to the categories and into which the services are sorted according to service contents are set, the storage 22C stores information of different fees corresponding to the plurality of sub-categories, and the connection permission controller 22D is configured to read information of a fee corresponding to one of the sub-categories from the storage 22C based on the desired service information, to permit connection between the customer service terminal 31 of the target business operator and the client terminal 11 in response to the customer paying the fee in a case of the fee being charged, and to permit connection between the customer service terminal 31 of the target business operator and the client terminal 11 in a case of the fee being free.

In this configuration, even if different fees are set for respective service contents of the same type of business, the fees are stored in the storage 22C. Therefore, a configuration is realized in which a service is provided to the customer after the fee is collected from the customer.

In the remote customer service system according to the present disclosure, the terminal obtainer 11A is configured to obtain the desired service information by reading information from a medium held by the customer.

This configuration makes it possible to obtain information about the service desired by the customer without the customer operating the client terminal 11 and the like. This makes the system easier to use for customers who are unfamiliar with the operation of the client terminal 11 and the like. Moreover, it is possible to promote the use of the remote customer service system by attaching the information to receipts issued at the time of shopping, magazine articles and the like and issuing and distributing such receipts, magazine articles, and the like as media that can be read by the terminal obtainer 11A.

The remote customer service system according to the present disclosure includes a medium issuer (the cash register 1B, the multifunctional copy machine 1C, or the multifunctional information communication terminal 1D) configured to issue the medium in the store (the convenience store 1) including the customer booth (consultation booth 1A).

This configuration enables the customer to easily obtain the medium to be read by the terminal obtainer 11A at the store (the convenience store 1).

The remote customer service system according to the present disclosure includes a billing information generator 22I configured to generate billing information for the business operator based on the status of connection to the business operator.

This configuration enables the provider of the remote customer service system to charge the target business operator a usage fee of the system and the like.

In the remote customer service system according to the present disclosure, the billing information generator 22I is configured to generate the billing information based on a connection count of connection to the business operator.

This configuration enables the provider of the remote customer service system to charge the target business operator a usage fee of the system and the like corresponding to the connection count.

In the remote customer service system according to the present disclosure, the billing information generator 22I is configured to generate the billing information based on a connection time of connection to the business operator.

This configuration enables the provider of the remote customer service system to charge the target business operator a usage fee of the system and the like corresponding to the connection time.

The remote customer service system according to the present disclosure includes an upper limit time setting unit 22F configured to set an upper limit time for a continuous connection time for which the client terminal 11 and the business operator are connected, and the upper limit time setting unit 22F is configured to automatically cut off the connection between the client terminal 11 and the business operator in response to the continuous connection time reaching the upper limit time.

This configuration makes it possible to set the time for consultation or the like between the customer and the customer service staff to be no longer than the upper limit time, and it becomes easy to strictly control a time frame for free consultation, paid consultation, and the like.

In the remote customer service system according to the present disclosure, the upper limit time setting unit 22F is configured to maintain the connection between the client terminal 11 and the business operator beyond the original upper limit time in response to an operation made by the customer service staff.

This configuration makes it possible to flexibly extend the upper limit time or make the upper limit time ineffective when a business meeting or the like between the customer and the customer service staff is prolonged.

The remote customer service system according to the present disclosure includes: a necessary document determiner 22G configured to determine a necessary document for the service desired by the customer based on the desired service information; and a notification controller 22H configured to control the notification device 11C of the client terminal 11 to notify the customer of the determined necessary document.

This configuration enables the customer to appropriately recognize the necessary document.

In the remote customer service system according to the present disclosure, the notification controller 22H controls the notification device 11C of the client terminal 11 to give a notification prompting the customer to obtain the necessary document at the store (the convenience store 1) where the client terminal 11 is installed.

Even if the customer does not have the necessary document, this configuration enables the customer to obtain the necessary document appropriately at the store (the convenience store 1).

The remote customer service system according to the present disclosure includes a coupon issuer 11D configured to issue, in response to the connection controller 22E connecting the customer service terminal 31 of the target business operator and the client terminal 11, a coupon usable at the store (the convenience store 1) where the client terminal 11 is installed or a nearby store.

This configuration makes it possible to prompt the customer to buy products at the store (the convenience store 1) and the like, which will benefit both the store and the customer. This facilitates installation of the client terminal 11 in stores.

The present disclosure relates to a connection server 22 configured to connect a client terminal 11 in a customer booth (consultation booth 1A), which is operated by a customer, and a target business operator which is one of a plurality of business operators providing services to realize remote conversation between the customer and a customer service staff who operates a customer service terminal 31 of the target business operator, the connection server 22 including: an information receiver 22A configured to receive desired service information indicative of a service desired by the customer from the client terminal 11; and a connection controller 22E configured to connect the client terminal 11 and the customer service terminal 31 of the target business operator determined in accordance with the received desired service information.

According to this configuration, the information receiver 22A of the connection server 22 obtains information about the service desired by the customer, and the connection controller 22E connects the customer service terminal 31 and the client terminal 11, whereby conversation between the customer and the customer service staff is realized. Accordingly, one business operator is selected from the plurality of business operators providing services according to the service desired by the customer, and it becomes easier for the selected business operator to provide an appropriate service to the customer. Therefore, the connection server 22 that can provide various services to customers is realized.

The present disclosure relates to a method performed in a remote customer service system configured to connect a client terminal 11 in a customer booth (consultation booth 1A), which is operated by a customer, and a target business operator which is one of a plurality of business operators providing services to realize remote conversation between the customer and a customer service staff who operates a customer service terminal 31 of the target business operator, the method including: an obtaining step of obtaining desired service information indicative of a service desired by the customer with use of the client terminal 11; a transmitting step of transmitting the desired service information obtained in the obtaining step from the client terminal 11; and a connecting step of connecting the client terminal 11 and the customer service terminal 31 of the target business operator determined in accordance with the desired service information transmitted from the client terminal 11.

According to this configuration, information about the service desired by the customer is obtained in the obtaining step, and the customer service terminal 31 and the client terminal 11 are connected in the connecting step, whereby conversation between the customer and the customer service staff is realized. Accordingly, one business operator is selected from the plurality of business operators providing services according to the service desired by the customer, and it becomes easier for the selected business operator to provide an appropriate service to the customer. Therefore, a method with which it is possible to provide various services to customers is realized.

### OTHER EMBODIMENTS

The present disclosure is not limited to the configurations described as examples in the above embodiment. The following describes representative other embodiments of the present disclosure.

(1) In the above embodiment, the determiner 22B determines a target business operator to which the client terminal is to be connected, from the plurality of business operators based on a signal from the intermediary terminal 21 operated by an operator. There is no limitation to this embodiment, and the determiner 22B may also be configured to automatically determine the target business operator from the plurality of business operators in accordance with the received desired service information. For example, the determiner 22B may automatically determine the target business operator based on an operation made on the client terminal 11 (for example, an operation made on the touch panel screen) by the customer. For example, the connection server 22 may have an interactive AI chat function and analyze the content of a speech or text input by the customer to obtain desired service information, and the determiner 22B may automatically determine the target business operator based on the desired service information. Then, the connection controller 22E may connect the client terminal 11 and the customer service terminal 31 of the target business operator determined by the determiner 22B.

(2) In the above embodiment, the client terminals 11 are respectively installed in a plurality of stores, and the storage 22C may also be configured to store information of different fees corresponding to the plurality of stores. In this case, the connection permission controller 22D may read, from the storage 22C, information of a fee corresponding to the store where the customer uses the client terminal 11 among the plurality of stores, to permit the connection between the customer service terminal 31 of the target business operator and the client terminal 11 installed in that store in response to the customer paying the fee in a case of the fee being charged, and to permit the connection between the customer service terminal 31 of the target business operator and the client terminal 11 installed in that store in a case of the fee being free.

(3) In the above embodiment, the intermediary terminal 21 includes the notification device 21A and the input interface 21B. The notification device 21A notifies the operator of the desired service information received from the information transmitter 11B. There is no limitation to this embodiment, and a configuration is also possible in which the client terminal 11 includes a human sensor, for example, and the notification device 21A notifies the operator in response to the human sensor detecting a person using the client terminal 11.

(4) In the above embodiment, the consultation booth 1A and the client terminal 11 are provided in the convenience store 1. There is no limitation to this embodiment, and the consultation booth 1A and the client terminal 11 may be provided in, for example, a personal store, a branch of a financial institution, a store provided in a section of a telephone exchange base station, or a store attached to a guest house in a remote island or the like.

(5) Two or more consultation booths 1A may also be provided in the convenience store 1. In this case, it is possible to provide, in the convenience store 1, two types of consultation booths 1A including a first type that has a large space enabling wheelchair access and a second type that is narrower than the first type.

(6) In the above embodiment, a configuration is described as an example in which the terminal obtainer 11A obtains desired service information by reading information from a medium held by the customer. There is no limitation to this embodiment, and the terminal obtainer 11A may also obtain desired service information by performing short-range wireless communication with a smartphone held by the customer, for example.

(7) The billing information generator 22I may also be configured to generate billing information based on at least one of the connection count and the connection time of connection to the business operator.

Note that the configurations disclosed in the above embodiment (including the other embodiments, the same applies hereinafter) can be applied in combination with configurations disclosed in other embodiments, as long as there is no contradiction. In addition, the embodiments disclosed in this specification are examples, and embodiments of the present disclosure are not limited to the disclosed embodiments, and may be modified as appropriate within the scope not departing from the object of the present disclosure.

The present disclosure is applicable to a remote customer service system, a connection server, and a method used in a remote customer service system.

What is claimed is:

1. A remote customer service system configured to connect a client terminal in a customer booth, which is operated by a customer, and a target business operator which is one of a plurality of business operators providing services to realize remote conversation between the customer and a customer service staff who operates a customer service terminal of the target business operator, the remote customer service system comprising:
a terminal obtainer included in the client terminal and configured to obtain desired service information indicative of one of the services desired by the customer;
an information transmitter included in the client terminal and configured to transmit the desired service information obtained by the terminal obtainer; and
a connection controller configured to connect the client terminal and the customer service terminal of the target business operator determined in accordance with the desired service information received from the information transmitter.

2. The remote customer service system according to claim 1, further comprising:
a determiner configured to automatically determine the target business operator from the plurality of business operators in accordance with the received desired service information,
wherein the connection controller is configured to connect the client terminal and the customer service terminal of the target business operator determined by the determiner.

3. The remote customer service system according to claim 1, further comprising:
an intermediary terminal configured to be operated by an operator,
the intermediary terminal including:
a notification device configured to notify the operator of the desired service information received from the information transmitter; and
an input interface configured to receive, from the operator, input of the target business operator determined by the operator,
wherein the connection controller is configured to connect the client terminal and the customer service terminal of the target business operator received by the input interface.

4. The remote customer service system according to claim 1,
wherein a plurality of categories into which the services are sorted according to types of businesses are set, and
the remote customer service system further comprises:
a storage storing information of different fees corresponding to the plurality of categories; and
a connection permission controller configured to read information of a fee corresponding to one of the categories from the storage based on the desired service information, to permit connection between the customer service terminal of the target business operator and the client terminal in response to the customer paying the fee in a case of the fee being charged, and to permit connection between the customer service terminal of the target business operator and the client terminal in a case of the fee being free.

5. The remote customer service system according to claim 4,
wherein a plurality of sub-categories that belong to the categories and into which the services are sorted according to service contents are set,
the storage stores information of different fees corresponding to the plurality of sub-categories, and
the connection permission controller is configured to read information of a fee corresponding to one of the sub-categories from the storage based on the desired service information, to permit connection between the customer service terminal of the target business operator and the client terminal in response to the customer paying the fee in a case of the fee being charged, and to permit connection between the customer service terminal of the target business operator and the client terminal in a case of the fee being free.

6. The remote customer service system according to claim 5,
wherein the client terminal is installed in each of a plurality of stores,
the remote customer service system further comprises:
a storage storing information of different fees corresponding to the plurality of stores; and
a connection permission controller configured to read, from the storage, information of a fee corresponding to a store in which the customer uses the client terminal among the plurality of stores, to permit connection between the customer service terminal of the target business operator and the client terminal in the store in response to the customer paying the fee in a case of the fee being charged, and to permit connection between the customer service terminal of the target business operator and the client terminal in the store in a case of the fee being free.

7. The remote customer service system according to claim 1,
wherein the terminal obtainer is configured to obtain the desired service information by reading information from a medium held by the customer.

8. The remote customer service system according to claim 7, further comprising:
a medium issuer configured to issue the medium in a store including the customer booth.

9. The remote customer service system according to claim 1, further comprising:
a billing information generator configured to generate billing information for the business operator based on a status of connection to the business operator.

10. The remote customer service system according to claim 9,
wherein the billing information generator is configured to generate the billing information based on a connection count of connection to the business operator.

11. The remote customer service system according to claim 9,
wherein the billing information generator is configured to generate the billing information based on a connection time of connection to the business operator.

12. The remote customer service system according to claim 1, further comprising:
an upper limit time setting unit configured to set an upper limit time for a continuous connection time for which the client terminal and the business operator are connected,
wherein the upper limit time setting unit is configured to automatically cut off connection between the client terminal and the business operator in response to the continuous connection time reaching the upper limit time.

13. The remote customer service system according to claim 12,
wherein the upper limit time setting unit is configured to maintain the connection between the client terminal and the business operator beyond the original upper limit time in response to an operation made by the customer service staff.

14. The remote customer service system according to claim 1, further comprising:
a necessary document determiner configured to determine a necessary document for the service desired by the customer based on the desired service information; and
a notification controller configured to control a notification device of the client terminal to notify the customer of the determined necessary document.

15. The remote customer service system according to claim 14,
wherein the notification controller controls the notification device of the client terminal to give a notification prompting the customer to obtain the necessary document at a store in which the client terminal is installed.

16. The remote customer service system according to claim 1, further comprising:
a coupon issuer configured to issue, in response to the connection controller connecting the customer service terminal of the target business operator and the client terminal, a coupon usable at a store in which the client terminal is installed or a nearby store.

17. A connection server configured to connect a client terminal in a customer booth, which is operated by a customer, and a target business operator which is one of a plurality of business operators providing services to realize remote conversation between the customer and a customer service staff who operates a customer service terminal of the target business operator, the connection server comprising:
an information receiver configured to receive desired service information indicative of one of the services desired by the customer from the client terminal; and
a connection controller configured to connect the client terminal and the customer service terminal of the target business operator determined in accordance with the received desired service information.

18. A method performed in a remote customer service system configured to connect a client terminal in a customer booth, which is operated by a customer, and a target business operator which is one of a plurality of business operators providing services to realize remote conversation between the customer and a customer service staff who operates a customer service terminal of the target business operator, the method comprising:
an obtaining step of obtaining desired service information indicative of one of the services desired by the customer with use of the client terminal;
a transmitting step of transmitting the desired service information obtained in the obtaining step from the client terminal; and
a connecting step of connecting the client terminal and the customer service terminal of the target business operator determined in accordance with the desired service information transmitted from the client terminal.
